(19) United States
(12) Patent Application Publication
(10) Pub. No.: US 2010/0128211 A1
(43) Pub. Date: May 27, 2010

(54) BIREFRINGENT FILM, LAMINATED FILM, AND IMAGE DISPLAY DEVICE

(75) Inventors: Shoichi Matsuda, Ibaraki-shi (JP); Junzo Miyazaki, Ibaraki-shi (JP); Tetsuo Inoue, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/594,134

(22) PCT Filed: Mar. 3, 2008
(86) PCT No.: PCT/JP2008/053746

§ 371 Date: Sep. 30, 2009

(30) Foreign Application Priority Data
Mar. 30, 2007 (JP) 2007-091241

(51) Int. Cl. G02F 1/13363; G02B 5/30; C09K 19/34

(52) U.S. Cl. 349/117; 359/500; 252/299.61

(57) ABSTRACT

The present invention provides a thin and light-weight birefringent film having a desired Nz coefficient, such that an index ellipsoid satisfies a relationship of nx≧nz>ny.

The birefringent film of the present invention contains a first acenaphtho[1,2-b]quinoxaline derivative exhibiting lyotropic liquid crystallinity and a second acenaphtho[1,2-b]quinoxaline derivative exhibiting lyotropic liquid crystallinity, wherein an index ellipsoid satisfies a relationship of nx≧nz>ny. An Nz coefficient of this birefringent film is preferably 0 to 0.5.

### TECHNICAL FIELD

The present invention relates to a birefringent film which is appropriate as a component member of an image display device, a laminated film having the birefringent film, and the image display device having the birefringent film.

### BACKGROUND ART

A liquid crystal display is one of image display devices for displaying characters and images by utilizing electro-optical properties of liquid crystal molecules. However, the liquid crystal display utilizes liquid crystal molecules having optical anisotropy, so that excellent display properties are exhibited in one direction, while a screen becomes dark or unclear in other directions. Therefore, a birefringent film (also refers to as a retardation film or an optical compensation layer) exhibiting a predetermined retardation is provided with the liquid crystal display.

A birefringent film having an index ellipsoid satisfying a relationship of nx>nz>ny and an Nz coefficient of 0.1 to 0.9 has been conventionally known as one of birefringent films (Patent Document 1). The birefringent film satisfying such a relationship of refractive index may be generally produced by attaching a shrinkable film on both surfaces of a polymeric film, and drawing the polymeric film in the thickness direction.

Patent Document 1: Japanese Unexamined Patent Publication No. 2006-72309

### DISCLOSURE OF THE INVENTION

However, the birefringent film composed of the polymeric film produced as described above tends to become thick. Therefore, a liquid crystal display provided with such a birefringent film becomes comparatively thick and heavy. Thus, the request for reducing the thickness and weight of the liquid crystal display may not be responded.

In optical compensation using a birefringent film satisfying a relationship of nx>nz>ny, a birefringent film (A) with an Nz coefficient of 0.25 and a birefringent film (B) with an Nz coefficient of 0.75 are occasionally laminated. The optical compensation using such two films of the birefringent films (A) and (B) is performed for a liquid crystal display in IPS (In-Plane Switching) mode, for example. In this case, the birefringent film (A) and (B) each having a specific Nz coefficient need to be produced.

However, it is difficult to produce the birefringent film having a specific Nz coefficient as described above with reduced thickness and also comparatively easily, and improvement method therefor is demanded.

An object of the present invention is to provide a thin and light-weight birefringent film having a desired Nz coefficient, such that an index ellipsoid satisfies a relationship of nx≧nz>ny.

Another object of the present invention is to provide a laminated film having the birefringent film and an image display device having the birefringent film.

A birefringent film of the present invention is characterized in that the birefringent film contains a first acenaphtho[1,2-b]quinoxaline derivative exhibiting lyotropic liquid crystallinity, represented by the following general formula (X1); and a second acenaphtho[1,2-b]quinoxaline derivative exhibiting lyotropic liquid crystallinity, represented by the following general formula (Y1). An index ellipsoid thereof satisfies a relationship of nx≧nz>ny.

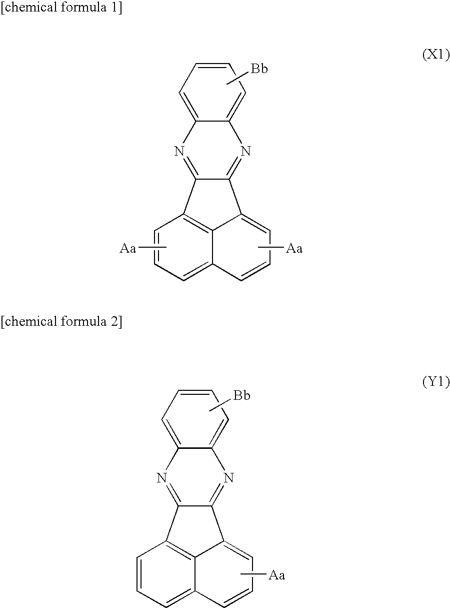

Here, in the formula (X1) and the formula (Y1), A each independently represents a substituent selected from —COOM, —SO₃M, —PO₃M, —OM, —NH₂, and —CONH₂ (M is a counterion); a represents a substitution number thereof (an integer of 1 to 3); B each independently represents a substituent selected from a halogen atom, —COOM, —SO₃M, —PO₃M, —OM, —NH₂, —NO₂, —CF₃, —CN, —OCN, —SCN, —CONH₂, —OCOCH₃, —NHCOCH₃, an alkyl group with a carbon number of 1 to 4, and an alkoxy group with a carbon number of 1 to 4 (M is a counterion); and b represents a substitution number thereof (an integer of 0 to 4).

The birefringent film contains a first acenaphtho[1,2-b]quinoxaline derivative exhibiting lyotropic liquid crystallinity and a second acenaphtho[1,2-b]quinoxaline derivative exhibiting lyotropic liquid crystallinity. Thus, the birefringent film may be formed by solution coating, for example. Accordingly, the birefringent film of the present invention may be thinly formed. Such a thin birefringent film becomes light in weight.

The birefringent film contains a first acenaphtho[1,2-b]quinoxaline derivative represented by the general formula (X1) and a second acenaphtho[1,2-b]quinoxaline derivative represented by the general formula (Y1). Thus, in the birefringent film, an index ellipsoid satisfies a relationship of nx≧nz>ny. In addition, a birefringent film having a desired Nz coefficient may be produced by modifying the compounding ratio of the first acenaphtho[1,2-b]quinoxaline derivative and the second acenaphtho[1,2-b]quinoxaline derivative. Therefore, the present invention allows birefringent films different in Nz coefficient to be easily produced.

A laminated film of the present invention is characterized in that the birefringent film is laminated on another film.

In addition, an image display device of the present invention is characterized by being provided with the birefringent film.

The image display device provided with the birefringent film of the present invention is excellent in terms of reduced thickness and weight, and in viewing angle characteristics.

The birefringent film of the present invention is useful as an optical member for optical compensation of an image display device since the index ellipsoid satisfies the relationship of nx≧nz>ny. In addition, the birefringent film of the present invention may be formed so thin that the image display device provided with the birefringent film of the present invention is excellent in terms of reduced thickness and weight.

### BEST MODE FOR CARRYING OUT THE INVENTION

### Meaning of Terms in the Present Invention

In the present invention, the meaning of main terms is as follows.

‘Birefringent film’ indicates a film exhibiting birefringence (anisotropy in refractive index) in the plane and/or in the thickness direction. ‘Birefringent film’ includes, for example, a film having an in-plane birefringence index and/or a birefringence index in the thickness direction at a wavelength of 590 nm of 1×10⁻⁴ or more.

Terms ‘nx’ and ‘ny’ indicate refractive indexes in directions orthogonal to each other in the plane of a birefringent film (where nx>ny), and ‘nz’ indicates a refractive index in the thickness direction of a birefringent film.

‘In-plane birefringence index (Δn_{xy}[λ])’ indicates a difference between refractive indexes in the plane of a birefringent film at a temperature of 23° C. at a wavelength of λ(nm). The Δn_{xy}[λ] may be calculated by Δn_{xy}[π]=nx−ny.

‘Birefringent index (Δn_{xz}[λ]) in the thickness direction’ indicates a difference between refractive indexes in the thickness direction of a birefringent film at a temperature of 23° C. at a wavelength of λ (nm). The Δn_{xz}[α] may be calculated by Δn_{xz}[λ]=nx−nz.

‘In-plane retardation value (Re[λ])’ indicates an in-plane retardation value of a birefringent film at a temperature of 23° C. at a wavelength of λ (nm). The Re[λ] may be calculated by Re[λ]=(nx−ny)×d when the thickness of a birefringent film is regarded as d (nm).

‘Retardation value (Rth[λ]) in the thickness direction’ indicates a retardation value in the thickness direction of a birefringent film at a temperature of 23° C. at a wavelength of λ(nm). The Rth[λ] may be calculated by Rth[λ]=(nx−nz)×d when the thickness of a birefringent film is regarded as d(nm).

‘Nz coefficient’ is a value calculated by Rth[λ]/Re[λ]. In the present invention, the Nz coefficient is a value calculated by Rth[590]/Re[590] based on a wavelength of 590 nm. The meanings of Rth[590] and Re[590] are as described above.

Each of these values may be measured by methods described in the following examples.

‘Lyotropic liquid crystallinity’ indicates the property of causing phase transition of isotropic phase-liquid crystalline phase by changing temperature or concentration of a compound (solute). The liquid crystalline phase may be confirmed and distinguished by an optical pattern of the liquid crystalline phase observed with a polarization microscope.

### <Birefringent Film of the Present Invention>

A birefringent film of the present invention contains a first acenaphtho[1,2-b]quinoxaline derivative exhibiting lyotropic liquid crystallinity, represented by the following general formula (X1); and a second acenaphtho[1,2-b]quinoxaline derivative exhibiting lyotropic liquid crystallinity, represented by the following general formula (Y1). An index ellipsoid of the birefringent film satisfies a relationship of nx≧nz>ny.

In the present specification, hereinafter, ‘first acenaphtho[1,2-b]quinoxaline derivative’ and ‘second acenaphtho[1,2-b]quinoxaline derivative’ are occasionally described as ‘first derivative’ and ‘second derivative’, respectively. ‘First derivative and second derivative’ are occasionally described as ‘first and second derivatives’.

Both the first derivative and the second derivative exhibit lyotropic liquid crystallinity in a solution state. These liquid crystalline phases are not particularly limited; and examples thereof include a nematic liquid crystalline phase, a smectic liquid crystalline phase, and a cholesteric liquid crystalline phase. The liquid crystalline phase is preferably a nematic liquid crystalline phase.

The first derivative is represented by the following general formula (X1) and the second derivative is represented by the following general formula (Y1).

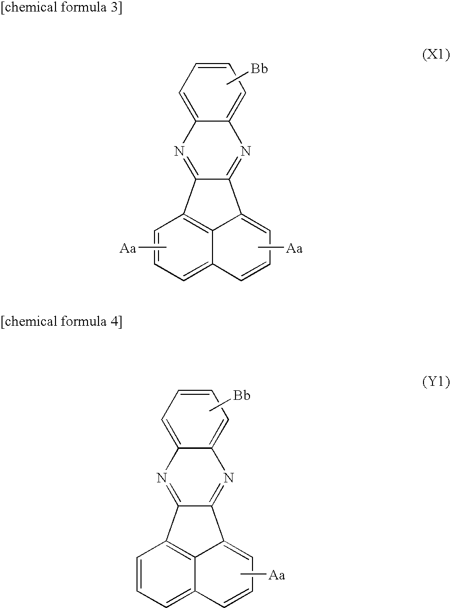

Here, in the formula (X1) and the formula (Y1), A each independently represents a substituent selected from —COOM, —SO₃M, —PO₃M, —OM, —NH₂, and —CONH₂ (M is a counterion); a represents a substitution number thereof (an integer of 1 to 3); B each independently represents a substituent selected from a halogen atom, —COOM, —SO₃M, —PO₃M, —OM, —NH₂, —NO₂, —CF₃, —CN, —OCN, —SCN, —CONH₂, —OCOCH₃, —NHCOCH₃, an alkyl group with a carbon number of 1 to 4, and an alkoxy group with a carbon number of 1 to 4 (M is a counterion); and b represents a substitution number thereof (an integer of 0 to 4).

The M is preferably a hydrogen ion, an alkali metal ion, an alkaline earth metal ion, an other metal ion, or a substituted or unsubstituted ammonium ion. The metal ion includes, for example, Ni²⁺, Fe³⁺, Cu²⁺, Ag⁺, Zn²⁺, Al³⁺, Pd²⁺, Cd²⁺, Sn²⁺, Co²⁺, Mn²⁺, Ce³⁺, or the like. For example, in the case where the birefringent film of the present invention is formed from a solution containing the first and the second derivatives, with regard to the M of the substituent, an ion for improving solubility in water is preferably used. These first and second derivatives are easily dissolved in water, so that a preferable aqueous solution can be prepared. Further, after forming a birefringent film by using this solution, the ion for improving solubility in water may be substituted with an ion insoluble or hardly soluble in water in order to enhance water resistance of the birefringent film.

The first derivative is preferably represented by the following general formula (X2) or the general formula (X3).

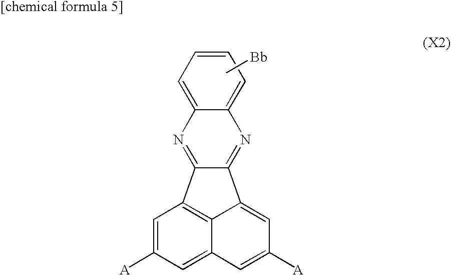

Here, in the formula (X2), A is the same as a substituent of the formula (X1), and B and b are the same as the formula (X1).

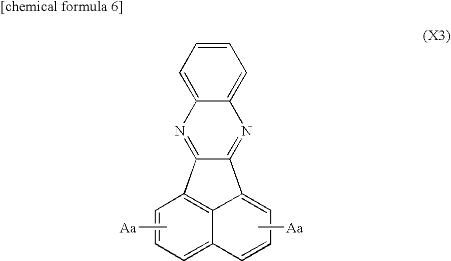

Here, in the formula (X3), A and a are the same as the formula (X1).

In the formula (X2), B is preferably a substituent selected from —COOM, —SO₃M, —PO₃M, —OM, —NH₂, —NO₂, —CONH₂, —OCOCH₃, and —NHCOCH₃, or unsubstituted; more preferably a substituent selected from —COOM, —SO₃M, —PO₃M, —OM, —NH₂, —NO₂, and —CONH₂, or unsubstituted; and particularly preferably —COOM, —SO₃M, or unsubstituted. The first derivative having such a substituent B or the first unsubstituted derivative is excellent in solubility in aqueous solvent.

In the formulae (X2) and (X3), A is preferably a substituent selected from —COOM, —SO₃M, and —NH₂; more preferably —COOM or —SO₃M; and particularly preferably —SO₃M. The first derivative having such a substituent A is excellent in solubility in aqueous solvent and can be formed into a film having an index ellipsoid satisfying a relationship of nx≧nz>ny.

In addition, in the formula (X3), the substitution number a of A is preferably 1, and the substitution site thereof is preferably 2-position and 5-position.

Next, the second derivative is preferably represented by the following general formula (Y2) or the general formula (Y3).

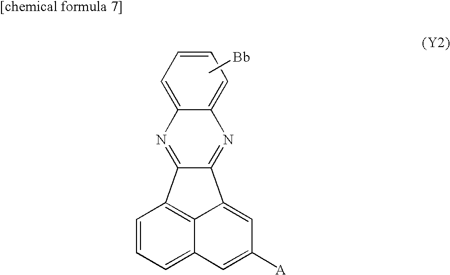

Here, in the formula (Y2), A is the same as a substituent of the formula (Y1), B and b are the same as the formula (Y1).

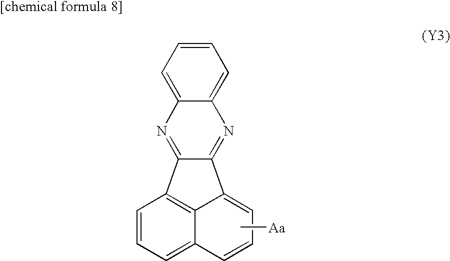

Here, in the formula (Y3), A and a are the same as the formula (Y1).

In the formula (Y2), B is preferably a substituent selected from —COOM, —SO₃M, —PO₃M, —OM, —NH₂, —NO₂, —CONH₂, —OCOCH₃, and —NHCOCH₃, or unsubstituted; more preferably a substituent selected from —COOM, —SO₃M, —PO₃M, —OM, —NH₂, —NO₂, and —CONH₂, or unsubstituted; and particularly preferably —COOM, —SO₃M, or unsubstituted. The second derivative having such a substituent B or the second unsubstituted derivative is excellent in solubility in aqueous solvent.

In the formulae (Y2) and (Y3), A is preferably a substituent selected from —COOM, —SO₃M, and —NH₂; more preferably —COOM or —SO₃M; particularly preferably —SO₃M. The second derivative having such a substituent A is excellent in solubility in aqueous solvent. Further, a film having an index ellipsoid satisfying a relationship of nx≧nz>ny can be formed by forming a solution containing the first derivative and the second derivative into a film.

In addition, in the formula (Y3), the substitution number a of A is preferably 1, and the substitution site thereof is preferably 2-position.

The first derivative represented by the formula (X1) and the second derivative represented by the formula (Y1) easily form an association in solution, and it is conceived that order in a state of forming this association is so high that a film formed from the solution also exhibits high alignment property. In particular, the first derivative and the second derivative having —SO₃M group and/or —COOM group are preferable since the above effect is sufficiently exerted.

The birefringent film may contain any optional additive in addition to the first derivative and the second derivative. The additive includes, for example, a plasticizer, a heat stabilizer, a light stabilizer, a lubricant, an antioxidant, a UV absorber, a flame retardant, a colorant, an antistat, a compatibilizer, a cross-linker, a thickener, and the like. Compounding ratio of the additive is preferably more than 0 and 10 or less parts by mass with respect to 100 parts by mass of the total content of the first derivative and the second derivative.

Among the first and second derivatives represented by the general formula (X1) and the general formula (Y1), a derivative such that A is sulfonic acid may be obtained by (a) sulfonation treatment of quinoxaline derivative, (b) dehydration condensation of aromatic diamine compound and acenaphthenequinone derivative, and the like, for example.

For example, as shown in the reaction formula (a), the first and second derivatives may be obtained by sulfonating acenaphtho[1,2-b]quinoxaline (or acenaphtho[1,2-b]quinoxaline having a substituent B such as carboxylic acid). Sulfuric acid, fuming sulfuric acid, or chlorosulfonic acid may be used for the sulfonation treatment. The first derivative represented by the general formula (X1) and the second derivative represented by the general formula (Y1) may be respectively obtained from the same starting material by adjusting a sulfonating temperature and reaction time of this sulfonation treatment.

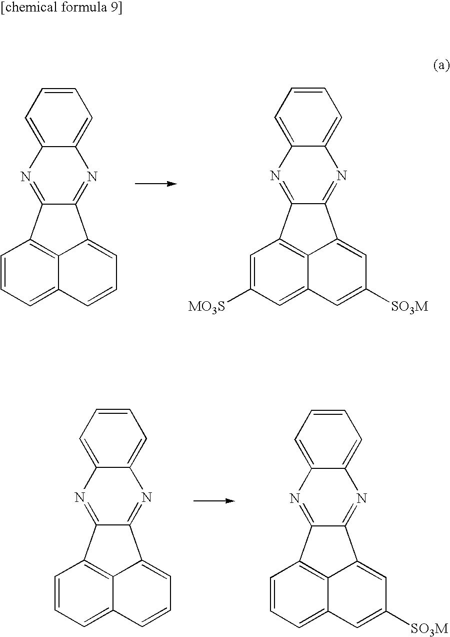

The first derivative can be obtained by, for example, condensation reaction of o-phenylene diamine (or o-phenylene diamine having a substituent B) with acenaphthenequinone disulfonic compounds such as acenaphthenequinone-2,5-disulfonic acid as described in the reaction formula (b). The second derivative can be obtained by, for example, condensation reaction of o-phenylene diamine (or o-phenylene diamine having a substituent B) with acenaphthenequinone sulfonic compounds such as acenaphthenequinone-2-sulfonic acid as described in the reaction formula (b).

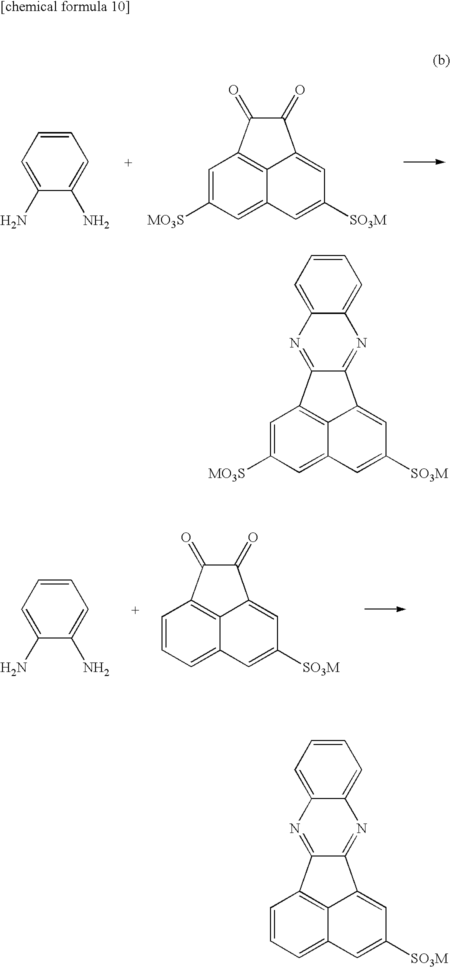

The birefringent film of the present invention may be produced in such a manner that the first derivative and the second derivative are blended at predetermined ratio and dissolved in an appropriate solvent into a state of liquid crystalline phase to coat and dry this solution on a base material. The coating film formed by coating and drying the solution on a base material is a birefringent film of the present invention. The first derivative and the second derivative form a stable liquid crystalline phase in the solution. Therefore, a transparent birefringent film with a high in-plane birefringence index, having no or less absorption in visible light range, may be obtained by a solvent casting method from the solution containing the first derivative and the second derivative.

The birefringent film of the present invention is formed into a film by solution coating. Therefore, the present invention provides a comparatively thin birefringent film.

The thickness of this birefringent film is preferably 0.05 μm or more and more preferably 0.1 μm or more. The upper limit of the thickness of the birefringent film is not particularly limited and properly adjusted in view of the in-plane retardation value and/or the retardation value in the thickness direction. The birefringent film is preferably thin, so that the thickness thereof is 10 μm or less, preferably 8 μm or less, and more preferably 6 μm or less.

Further, the index ellipsoid of the birefringent film satisfies a relationship of nx≧nz>ny (nx>nz>ny or nx=nz>ny) and the birefringent film has a comparatively high in-plane birefringence index. Even though the birefringent film is remarkably thin compared to conventional birefringent films, the birefringent film has a comparatively high retardation value.

Here, ‘nx=nz’ includes not only the case where nx and ny are completely identical, but also the case where they are substantially identical. Here, the case where they are substantially identical denotes, for example, the case where Rth[590] is −10 nm to 10 nm and preferably −5 nm to 5 nm.

According to the present invention, a birefringent film having a desired Nz coefficient is obtained by modifying the compounding ratio of the first derivative and the second derivative. Specifically, as is clear from the examples described below, for example, a higher compounding ratio of the first derivative allows a birefringent film having a lower Nz coefficient to be obtained, while a higher compounding ratio of the second derivative allows a birefringent film having a higher Nz coefficient to be obtained. Only by modifying the compounding ratio in this manner, a birefringent film having a desired Nz coefficient is easily obtained, which is an effect first found out by the inventors of the present invention. The inventors of the present invention assume the reason therefor as follows. That is to say, the first derivative has substituents A in both benzene rings of a naphthalene ring, respectively. The second derivative has a substituent A in one benzene ring of a naphthalene ring. A film formed from the first derivative exhibits lower Nz coefficient. On the other hand, a film formed from the second derivative exhibits higher Nz coefficient. The first derivative capable of forming a film having low Nz coefficient and the second derivative capable of forming a film having high Nz coefficient are intermingled in a compatible state in the birefringent film of the present invention. Thus, by modifying the compounding ratio thereof, a birefringent film having a desired Nz coefficient may be obtained.

As described above, the compounding ratio of the first derivative and the second derivative may be set so diversely that the amount of the first derivative and the second derivative contained in the birefringent film of the present invention is not particularly limited. For example, the birefringent film of the present invention contains by 1 part by mass to 99 parts by mass of the first derivative and by 1 part by mass to 99 parts by mass of the second derivative with respect to 100 parts by mass of the total solid content thereof.

In the case of using solution containing only the second derivative (containing no first derivative), the second derivative causes crystallization during film formation, so that it is difficult to obtain a birefringent film with high transmittance. It is assumed that the reason therefor is that the second derivative has a narrow concentration range of exhibiting lyotropic liquid crystallinity.

In the case of using the second derivative as a single substance in this manner, a birefringent film with low transmittance is obtained. However, as described above, a birefringent film with high transmittance and having different Nz coefficients in accordance with the compounding ratio is obtained by blending the first derivative and the second derivative.

The Nz coefficient of the present invention can be adjusted 0 or more and less than 1, preferably 0 to 0.9, more preferably 0 to 0.5, further preferably 0.05 to 0.45, particularly preferably 0.1 to 0.4, and most preferably 0.11 to 0.35. A birefringent film having the Nz coefficient in the above range can be utilized for optical compensation of a liquid crystal cell having various types of driving mode.

The single transmittance of the birefringent film at a wavelength of 590 nm is preferably 85% or more and more preferably 90% or more. The haze value of the birefringent film is preferably 5% or less, more preferably 4% or less, and particularly preferably 3% or less. The image display device having the birefringent film having the haze value in the above range is excellent in display properties. The haze value is a value measured according to JIS-K7105.

The in-plane birefringence index (Δn_{xy[}590]) of the birefringent film at a wavelength of 590 nm is preferably 0.05 to 0.5, more preferably 0.1 to 0.5, and particularly preferably 0.15 to 0.4. The birefringence index (Δn_{xz[}590]) in the thickness direction of the birefringent film at a wavelength of 590 nm is preferably 0 to 0.5, more preferably 0.001 to 0.3, and particularly preferably 0.001 to 0.2. The birefringent film having the in-plane birefringence index and/or the birefringence index in the thickness direction satisfies a relationship of nx≧nz>ny which is useful for improving of display properties of liquid crystal displays, and has a comparatively high retardation value.

The in-plane retardation value (Re[590]) of the birefringent film at a wavelength of 590 nm may be properly adjusted in accordance with purposes. The Re[590] is 10 nm or more, preferably 20 nm to 1000 nm, more preferably 50 nm to 500 nm, and particularly preferably 100 nm to 400 nm. The Rth[590] of the birefringent film at a wavelength of 590 nm may be adjusted in proper value as long as the index ellipsoid thereof satisfies a relationship of nx≧nz>ny. The Rth[590] of the birefringent film is preferably 0 nm to 1000 nm, more preferably 0 nm to 500 nm, and particularly preferably 10 nm to 200 nm.

The difference between the Re[590] and the Rth[590] of the birefringent film is preferably more than 0 nm and 500 nm or less, more preferably more than 0 nm and 200 nm or less, and particularly preferably more than 0 nm and 150 nm or less.

### <Producing Method for Birefringent Film of the Present Invention>

In one embodiment, a birefringent film of the present invention may be obtained by a producing method having each of the following steps.

Step (1): a step of preparing solution containing at least the first derivative, the second derivative, and a solvent, and exhibiting a liquid crystalline phase.

Step (2): a step of preparing a base material with at least one plane thereof hydrophilized.

Step (3): a step of coating and drying the solution of the step (1) on the hydrophilized plane of the base material of the step (2).

With regard to the step (1) and the step (2), either of the steps may be previously performed or both of the steps may be simultaneously performed, and the performing order does not matter.

### [Step (1)]

The step (1) is a step of preparing a solution containing at least the first derivative and the second derivative.

The first derivative and the second derivative may be properly selected from the examples described above. The first derivative may adopt one kind singly or two kinds or more selected from among the examples included in the formula (X1). The second derivative may adopt one kind singly or two kinds or more selected from among the examples included in the formula (Y1).

An optional solvent capable of dissolving the first derivative and the second derivative to develop a liquid crystalline phase (preferably a nematic liquid crystalline phase) is selected for the solvent.

The solvent may be an inorganic solvent such as water, or an organic solvent such as alcohol, ketone, ether, ester, amide, and cellosolve. As the organic solvent, for example, n-butanol, 2-butanol, cyclohexanol, isopropyl alcohol, t-butyl alcohol, glycerin, ethylene glycol, acetone, methyl ethyl ketone, methyl isobutyl ketone, cyclohexane, cyclopentanone, 2-pentanone, 2-hexanone, tetrahydrofuran, dioxane, acetic ether, butyl acetate, methyl lactate, dimethylformamide, dimethylacetamide, N-methylpyrrolidone, methylcellosolve, ethylcellosolve, and the like may be used. The solvent is used singly or in combination of two kinds or more.

The solvent is preferably an aqueous solvent and particularly preferably water. Electric conductivity of water is preferably 20 μS/cm or less, more preferably 0.001 μS/cm to 10 μS/cm, and particularly preferably 0.001 μS/cm to 5 μS/cm. The lower limit of the electric conductivity of water is 0 μS/cm. By use of water in which the electric conductivity is within the above range, a birefringent film having a high in-plane birefringence index and/or a high birefringence index in the thickness direction may be obtained.

A concentration of the first and second derivatives in the solution is prepared within appropriate range if the solution exhibits a liquid crystalline phase. The total concentration of the first and second derivatives in the solution is preferably 3% by mass to 40% by mass, more preferably 3% by mass to 30% by mass, particularly preferably 5% by mass to 30% by mass, and most preferably 10% by mass to 30% by mass. The solution having the concentration within the above range may form a stable liquid crystalline state.

In the solution, an optional additive may be added. Examples of the additive include a surfactant, a plasticizer, a heat stabilizer, a light stabilizer, a lubricant, an antioxidant, a UV absorber, a flame retardant, a colorant, an antistat, a compatibilizer, a cross-linker, a thicker, and the like. The additive amount of these additives is preferably more than 0 and 10 or less parts by mass with respect to 100 parts by mass of the solution.

In the solution, a surfactant may be added. The surfactant is added for improving wettability and coatability of the solution containing the first and second derivatives to the base material surface. The surfactant is preferably a nonionic surfactant. An additive amount of the surfactant is preferably more than 0 and 5 parts or less by mass with respect to 100 parts by mass of the solution.

### [Step (2)]

The step (2) is a step of preparing a base material with at least one surface thereof hydrophilized. In the present specification, lydrophilization treatment' indicates treatment for decreasing a contact angle of water on the base material. The hydrophilization treatment is performed for improving wettability and coatability of the base material surface with respect to the solution containing the first and second derivatives.

The hydrophilization treatment includes a treatment for decreasing the contact angle of water on the base material at a temperature of 23° C. preferably by 10% or more, more preferably by 15% to 80%, and particularly preferably by 20% to 70% as compared with a state before the treatment. Here, this decreasing ratio (%) is calculated by the expression; {(contact angle before treatment−contact angle after treatment)/contact angle before treatment}×100.

In addition, the hydrophilization treatment is a treatment for decreasing the contact angle of water on the base material at a temperature of 23° C. preferably by 5° or more, more preferably by 10° to 65°, and particularly preferably by 20° to 60° as compared with a state before the treatment.

The hydrophilization treatment includes a treatment for setting the contact angle of water on the base material at a temperature of 23° C. preferably by 5° to 60°, more preferably by 5° to 50°, and particularly preferably by 5° to 45°. By setting the contact angle of water on the base material within the above range, a birefringent film having a high in-plane birefringence index and small thickness dispersion may be obtained.

The hydrophilization treatment can be any appropriate and optional method. For example, the hydrophilization treatment may be a dry treatment or a wet treatment. The dry treatment includes, for example, a discharge treatment such as a corona treatment, a plasma treatment, or a glow discharge treatment; a flame treatment; an ozone treatment; an ionization active ray treatment such as a UV ozone treatment, an ultraviolet treatment, or an electron beam treatment; and the like. The wet treatment includes, for example, an ultrasonic treatment using a solvent such as water or acetone; an alkali treatment; an anchor coat treatment; and the like. The treatment can be used singly or in combination of two kinds or more.

The hydrophilization treatment is preferably the corona treatment, the plasma treatment, the alkali treatment, or the anchor coat treatment. The use of these hydrophilization treatments allows a birefringent film having a high alignment and small thickness dispersion to be obtained. With regard to the condition of the hydrophilization treatment (for example, treating time or intensity), it can be set to be a suitable and appropriate value as far as the contact angle of water on the base material is within the above range.

The corona treatment is typically a treatment for modifying the base material surface by passing the base material through corona discharge. The corona discharge is caused in such a manner that air between the electrodes is subjected to dielectric breakdown and ionized by impressing high frequency and high voltage between a grounded dielectric roll and an insulated electrode. The plasma treatment is typically a treatment for modifying the base material surface by passing the base material through low-temperature plasma. The low-temperature plasma is caused in such a manner that glow discharge is caused in inorganic gases such as low-pressure inert gas, oxygen gas, and halogen gas, and then a part of the gaseous molecules are ionized. The ultrasonic treatment is typically a treatment for removing contaminations on the base material and improving wettability thereof. The ultrasonic treatment is performed such that the base material is immersed in water or an organic solvent and irradiated with ultrasonic waves. The alkali treatment is typically a treatment for modifying the base material surface by immersing the base material in an alkali treatment solution such that a basic material is dissolved in water or an organic solvent. The anchor coat treatment is typically a treatment for coating the base material surface with an anchor coat agent.

The base material of the present invention is a material used for uniformly developing the above solution containing the first derivative, the second derivative, and the solvent. The base material may be selected optionally and appropriately. The base material is, for example, a glass substrate, a quartz substrate, a polymeric film, a plastic substrate, a metal substrate made of aluminum or iron, a ceramic substrate, a silicon wafer, and the like. The base material is preferably the glass substrate or the polymeric film.

The glass substrate is not particularly limited and may be selected appropriately. The glass substrate is, for example, a glass substrate used for a liquid crystal cell generally. Examples of the glass substrate include soda-lime glass (blue sheet) containing an alkaline component, or low-alkali borax acid glass. A commercial glass substrate may be directly used for the glass substrate. Examples of the commercial glass substrate include glass code: 1737 manufactured by Corning Incorporated, glass code: AN635 manufactured by Asahi Glass Co., Ltd. and glass code: NA-35 manufactured by NH Techno Glass Corporation.

A resin forming the polymeric film is not particularly limited. The polymeric film preferably contains a thermoplastic resin. The thermoplastic resin includes, for example, a polyolefin-based resin, a cycloolefin-based resin, a polyvinyl chloride-based resin, a cellulose-based resin, a styrene-based resin, a polymethylmethacrylate, a polyvinyl acetate, a polyvinylidene chloride-based resin, a polyamide-based resin, a polyacetal-based resin, a polycarbonate-based resin, a polybutylene terephthalate-based resin, a polyethylene terephthalate-based resin, a polysulphone-based resin, a polyether sulphone-based resin, a polyether ether ketone-based resin, a polyarylate-based resin, a polyamide-imide-based resin, a polyimide-based resin, and the like. These thermoplastic resins are used singly or in combination of two kinds or more. The thermoplastic resin may be also used after performing optional and appropriate polymer modification. Examples of the polymer modification include copolymerization, crosslinking, molecular ends, and stereoregularity.

The polymeric film is preferably a film excellent in light transmittance in visible light and transparency. The light transmittance of the polymeric film in visible light is preferably 80% or more and more preferably 90% or more. Here, the light transmittance is a Y value at a film thickness of 100 μm, where the Y value is obtained by correcting visibility based on spectrum data measured by a spectrophotometer (trade name of U-4100 type, manufactured by Hitachi, Ltd.). Also, a haze value of the polymeric film is preferably 3% or less and more preferably 1% or less. Here, the haze value is a value measured according to JIS-K7105.

In the case where the base material is the polymeric film, the base material may be used as a protective film after forming a birefringent film thereon.

The base material is preferably a polymeric film containing a cellulose-based resin. The base material containing the cellulose-based resin is excellent in wettability of the solution containing the first and second derivatives, therefore a birefringent film having small thickness dispersion may be obtained by using this base material.

The cellulose-based resin is not particularly limited and may be selected appropriately. The cellulose-based resin is preferably a cellulose organic acid ester or a cellulose mixed organic acid ester, in which a part or all of hydroxyl groups of the cellulose are substituted with acetyl groups, propionyl groups and/or butyl groups. Examples of the cellulose organic acid ester include cellulose acetate, cellulose propionate, cellulose butyrate, and the like. Examples of the cellulose mixed organic acid ester include cellulose acetate propionate, cellulose acetate butyrate, and the like. The cellulose-based resin may be obtained by the method described in [0040] and [0041] of Japanese Unexamined Patent Publication No. 2001-188128, for example.

A commercial polymeric film may be also directly used for the base material. Alternatively, a commercial polymeric film for which secondary elaborations are performed may be also used. This secondary elaboration includes a drawing treatment and/or a contraction treatment. Examples of the commercial polymeric film containing a cellulose-based resin include FUJITAC series (trade name of ZRF80S, TD80UF, and TDY-80UL) manufactured by Fuji Photo Film Co., Ltd. and trade name ‘KC8UX2M’, manufactured by Konica Minolta Opt, Inc.

The thickness of the base material is preferably 20 μm to 100 μm. The base material having the thickness within the above range is excellent in handling ability and the solution may be coated better.

### [Step (3)]

The step (3) is a step of coating and drying the solution prepared in the step (1) on the hydrophilized surface of the base material prepared in the step (2).

The coating speed of the solution is not particularly limited; however, it is preferably 10 mm/second or more, more preferably 50 mm/second or more, particularly preferably 100 mm/second or more. The upper limit of the coating speed is preferably 8000 mm/second, more preferably 6000 mm/second, and particularly preferably 4000 mm/second. By setting the coating speed in the above range, a shearing force appropriate for orienting the first and second derivatives is applied into the solution. Thus, a birefringent film having a high in-plane birefringence index and small thickness dispersion may be obtained.

With regard to a method for coating the solution on the base material surface, a coating method using an optional appropriate coater may be used. The coater includes, for example, a reverse roll coater, a positive rotation roll coater, a gravure roll coater, a knife coater, a rod coater, a slot die coater, a slot orifice coater, a curtain coater, a fountain coater, an air doctor coater, a kiss coater, a dip coater, a bead coater, a blade coater, a cast coater, a spray coater, a spin coater, an extrusion coater, a hot-melt coater, and the like. The coater is preferably the reverse roll coater, the positive rotation roll coater, the gravure roll coater, the rod coater, the slot die coater, the slot orifice coater, the curtain coater, and the fountain coater. When the solution is coated by using the coater, a birefringent film having small thickness dispersion may be obtained.

With regard to a method for drying the solution, an optional appropriate method may be used. The drying method includes, for example, an air-circulation thermostat oven in which hot air or cold air is circulated; a heater using a microwave, a far infrared ray, or the like; a roll, a heat pipe roll, or a metal belt, which are heated for temperature regulation; and the like.

The temperature for drying the solution is below or equal to the isotropic phase transition temperature of the solution, and the temperature is preferably raised gradually from a low temperature to a high temperature. The above drying temperature is preferably 10° C. to 80° C., and more preferably 20° C. to 60° C. Within such a temperature range, a birefringent film having small thickness dispersion can be obtained.

The period of time for drying the solution can be selected appropriately depending on the drying temperature or the kind of the solvent. In order to obtain a birefringent film having small thickness dispersion, the drying time is, for example, from 1 minute to 30 minutes, and preferably from 1 minute to 10 minutes.

### [Other Step]

A producing method for the birefringent film of the present invention preferably comprises a step (4) in addition after the above step (1) to (3).

Step (4): a step of bringing the film obtained in the above step (3) into contact with a solution containing at least one kind of a compound salt selected from the group consisting of aluminum salt, barium salt, lead salt, chromium salt, strontium salt, and compound salts having two or more amino groups within a molecule.

In the present invention, the step (4) is performed for imparting insolubility or difficult solubility in water to the obtained birefringent film. The compound salt includes, for example, aluminum chloride, barium chloride, lead chloride, chromium chloride, strontium chloride, 4,4′-tetramethyldiaminodiphenylmethane hydrochloride, 2,2′-dipyridyl hydrochloride, 4,4′-dipyridyl hydrochloride, melamine hydrochloride, tetraminopyrimidine hydrochloride, and the like. These compound salts allow a birefringent film excellent in water resistance to be obtained.

In the solution containing the above compound salt, the concentration of the compound salt is preferably 3% by mass to 40% by mass, and particularly preferably 5% by mass to 30% by mass. By bringing the birefringent film into contact with the solution containing the compound salt in the above range, a birefringent film excellent in water resistance can be obtained.

As a method of bringing the birefringent film obtained in the above step (3) into contact with the solution containing the above compound salt, an optional method can be used. This method is, for example, a method of coating the solution containing the above compound salt onto the surface of the birefringent film, a method of immersing the birefringent film into the solution containing the above compound salt, or the like. In the case where these methods are used, an obtained birefringent film is preferably washed with water or an optional solvent. After washing the birefringent film, a laminated film excellent in adhesion property of the interface between the base material and the birefringent film may be obtained by drying.

### <Use of Birefringent Film of the Present Invention>

A birefringent film of the present invention is not used for particularly limited uses, but used as an optical member of a liquid crystal display representatively. Examples of the optical member include a λ/4 plate, a λ/2 plate, and a view angle widening film, and an antireflection film for flat panel displays, and the like.

In one embodiment of the present invention, a polarizing plate may be provided by laminating a polarizer on the birefringent film of the present invention.

The polarizing plate is a laminated film comprising at least the birefringent film of the present invention and a polarizer. The polarizing plate may be further laminated the base material or another optical film. The another optical film includes, for example, a birefringent film different from the birefringent film of the present invention, an optionally protective film, and the like. Practically, an appropriate adhesive layer is provided between each of the layers of the polarizing plate and the layers are adhered respectively.

The adhering angle of the polarizer and the birefringent film in the polarizing plate may be properly set in accordance with purposes. In the case where the polarizing plate is used as an antireflection film, the polarizer and the birefringent film are adhered so that an angle between the absorption axis direction of the polarizer and the slow axis direction of the birefringent film becomes preferably 25° to 65°, and more preferably 35° to 55°. In the case where the polarizing plate is used as a viewing angle widening film, the polarizer and the birefringent film are adhered so that an angle between the absorption axis direction of the polarizer and the slow axis direction of the birefringent film becomes substantially parallel or substantially orthogonal. ‘Substantially parallel’ indicates that an angle between the absorption axis direction of the polarizer and the slow axis direction of the birefringent film includes a range of 0°±10° and is preferably 0°±5°. ‘Substantially orthogonal’ indicates that an angle between the absorption axis direction of the polarizer and the slow axis direction of the birefringent film includes a range of 90°±10° and is preferably 90°±5°.

The above polarizer is an optical film having the optical property of converting natural light or polarized light into linearly polarized light. The polarizer is preferably a drawn film having a polyvinyl alcohol-based resin as the main component and containing iodine or dichromatic dye. In general, the thickness of the polarizer is 5 μm to 50 μm.

The adhesive layer can be selected from any optional one as far as the adhesive layer joins planes of adjacent elements, which are integrated by practically sufficient adhesive force and adhesive time. Examples of a material for forming the adhesive layer include an adhesive agent, a pressure-sensitive agent, and an anchor coat agent. The adhesive layer may be a multi-layered structure such that an anchor coat layer is formed on the surface of an adherend to form an adhesive agent layer or a pressure-sensitive agent layer thereon, or a thin layer unrecognizable with the naked eye (also referred to as hairline). The adhesive layer disposed on one side of the polarizer and the adhesive layer arranged on the other side thereof may be the same or different.

The birefringent film and the laminated film comprising the birefringent film of the present invention can be mounted on various image display devices.

The image display device of the present invention includes an organic EL display, a plasma display, and others in addition to a liquid crystal display. A preferable use of the image displays is a television set, and particularly preferably a large-scale television set having a screen size of 40 inches or more. In the case where the image display device is a liquid crystal display, preferable use thereof is OA apparatus such as a television set, a personal computer monitor, a notebook personal computer, and a copying machine; portable apparatus such as a portable telephone, a watch, a digital camera, a portable digital assistance (PDA), and a portable game machine; a home-use electric apparatus such as a video camera and an electronic range; apparatus to be mounted on a vehicle such as a back monitor, a monitor for a car navigation system, and a car audio device; an exhibition apparatus such as an information monitor for commercial shops; guarding apparatus such as a monitor for supervision; and assisting and medical apparatus such as a monitor for assisting senior persons and a monitor for medical use.

### EXAMPLES

Hereinafter, the present invention is further described with reference to examples. However, the present invention is not limited to the following examples. Each measuring method used in the examples is as follows.

### (1) Measuring Method for Thickness:

A portion of the birefringent film formed on a base material was peeled and the thickness was measured as a step between the film and the base material by using a three-dimensional non-contact surface form measuring system (product name of ‘Micromap MM5200’, manufactured by Ryoka Systems Inc.).

### (2) Measuring Method for Transmittance (T[590]):

T[590] was measured at a temperature of 23° C. by using the trade name of V-4100′, manufactured by Hitachi, Ltd. The measuring wavelength was 380 nm to 780 nm, and 590 nm was regarded as the representative value.

(3) Measuring method for Δn_{xy[}590], Δn_{xz[}590], nx, ny, nz, Re[590], Rth[590], and Nz coefficient:

The Re[590] and the like were measured at a temperature of 23° C. by using the trade name of ‘KOBRA21-ADH’, manufactured by Oji Scientific Instruments. For average refractive index, it was measured by using an Abbe refractometer (trade name of ‘DR-M4’, manufactured by ATAGO Co., Ltd.).

### (4) Measuring Method for Electric Conductivity:

After an electrode of a solution electric conductivity meter (trade name of ‘CM-117’, manufactured by Kyoto Electronics Manufacturing Co., Ltd.) was washed in an aqueous solution in which the concentration was prepared at 0.05% by mass, a sample was filled into a 1-cm³ container connected to the electrode and the displayed electric conductivity showed a constant value, which was regarded as a measured value.

### (5) Measuring Method for Contact Angle of Water:

After water was dropped onto a birefringent film by using a solid-liquid interface analyzer (trade name of ‘prop Master 300’, manufactured by Kyowa Interface Science Co., Ltd.), a contact angle after 5 seconds was measured. The measurement condition was static contact angle measurement. Ultrapure water was used for water and droplets were 0.5 μl. The average value through ten repeated times was regarded as a measured value.

### (6) Confirmation Method for Liquid Crystalline Phase:

A solution was put between two sheets of slide glass, which were placed in a hot stage (trade name of ‘FP28HT’, manufactured by Mettler-Toledo K.K.) and thereafter observed by using a polarization microscope (trade name of ‘BX50’, manufactured by Olympus Corporation) while changing the temperature to confirm a liquid crystalline phase.

### Synthesis Example 1

### Synthesis of acenaphtho[1,2-b]quinoxaline

To a reaction vessel equipped with a stirrer, 5-liter of glacial acetic acid and 490 g of purified acenaphthenequinone were added and stirred for 15 minutes under nitrogen bubbling to obtain an acenathphenequinone solution. Similarly, to another reaction vessel equipped with a stirrer, 7.5-liter of glacial acetic acid and 275 g of o-phenylenediamine were added and stirred for 15 minutes under nitrogen bubbling to obtain an o-phenylenediamine solution. Thereafter, while stirring under nitrogen atmosphere, the o-phenylenediamine solution was added to the acenaphthenequinone solution gradually over one hour, and then allowed to react by continuing to stir for 3 hours. After ion exchange water was added to the obtained reaction liquid, the precipitate was filtrated to obtain a crude product containing acenaphtho[1,2-b]quinoxaline. This crude product was recrystallized with a heated glacial acetic acid for purification.

### Synthesis Example 2

### Synthesis of acenaphtho[1,2-b]quinoxaline-2,5-disulfonic acid

As represented by the following reaction pathway, 300 g of acenaphtho[1,2-b]quinoxaline obtained by synthesis example 1 was added to 30% fuming sulfuric acid (2.1-liter) and the mixture was stirred at room temperature for 24 hours, the resultant was heated to 125° C. and stirred for 32 hours for reaction. While keeping the obtained solution at 40° C. to 50° C., 4.5-liter of ion exchange water was added for dilution, and the resultant was further stirred for 3 hours. The precipitate was filtered and recrystallized with sulfuric acid to obtain acenaphtho[1,2-b]quinoxaline-2,5-disulfonic acid corresponding to the first derivative.

This reaction product was dissolved in 30-liter of ion exchange water (electric conductivity: 0.1 μS/cm) and further was neutralized by addition of an aqueous solution of sodium hydroxide. The obtained aqueous solution was put into a supply tank and, with use of a high-pressure RO element testing apparatus equipped with a reverse osmosis filter manufactured by Nitto Denko Corporation (trade name of ‘NTR-7430’), was subjected to circulation filtration while adding a reverse osmosis water so that the liquid amount would be constant, thereby removing the residual sulfuric acid until the electric conductivity of the exhaust liquid would be 13.6 μS/cm.

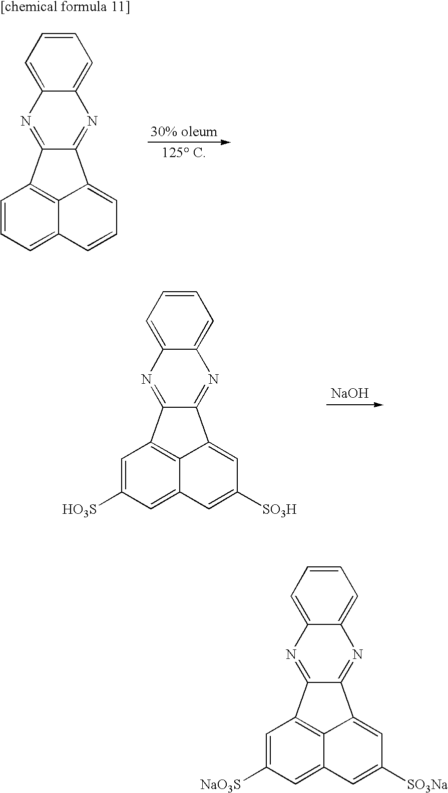

### Synthesis Example 3

### Synthesis of acenaphtho[1,2-b]quinoxaline-2-sulfonic acid

As represented by the following reaction pathway, 300 g of acenaphtho[1,2-b]quinoxaline obtained by synthesis example 1 was added to 30% fuming sulfuric acid (2.1-liter) and the mixture was stirred at room temperature for 48 hours for reaction. While keeping the obtained solution at 40° C. to 50° C., 4.5-liter of ion exchange water was added for dilution, and the resultant was further stirred for 3 hours. The precipitate was filtered to obtain acenaphtho[1,2-b]quinoxaline-2-sulfonic acid corresponding to the second derivative.

This reaction product was dissolved in 30-liter of ion exchange water (electric conductivity: 0.1 μS/cm) and further was neutralized by addition of an aqueous solution of sodium hydroxide. The obtained aqueous solution was put into a supply tank and, with use of a high-pressure RO element testing apparatus equipped with a reverse osmosis filter manufactured by Nitto Denko Corporation (trade name of ‘NTR-7430 filter element’), was subjected to circulation filtration while adding a reverse osmosis water so that the liquid amount would be constant, thereby removing the residual sulfuric acid until the electric conductivity of the exhaust liquid would be 8.1 μS/cm.

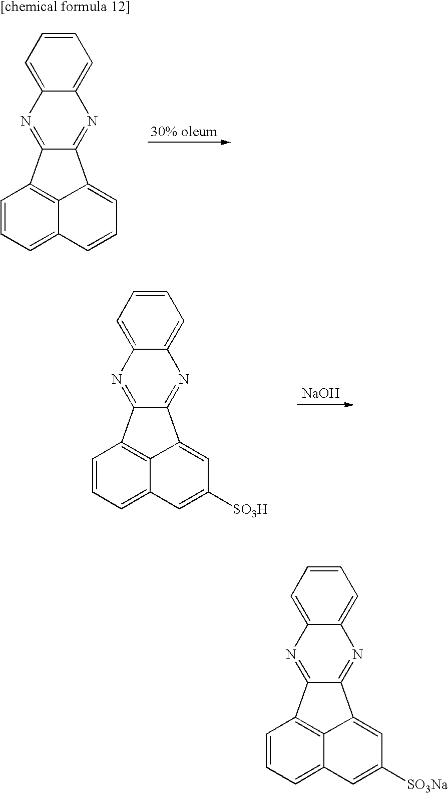

### Example 1

The aqueous solutions obtained in the above synthesis example 2 and synthesis example 3 were mixed so that the mixing ratio of the solid components of the acenaphtho[1,2-b]quinoxaline-2,5-disulfonic acid obtained in the above synthesis example 2 and the acenaphtho[1,2-b]quinoxaline-2-sulfonic acid obtained in the above synthesis example 3 would be 80:20. Next, this mixed aqueous solution was prepared by using a rotary evaporator so that the concentration of the aforesaid quinoxaline derivatives (total concentration of the acenaphtho[1,2-b]quinoxaline-2,5-disulfonic acid and the acenaphtho[1,2-b]quinoxaline-2-sulfonic acid) in the aqueous solution would be 25% by mass. When the prepared solution was observed with a polarization microscope, this solution exhibited a nematic liquid crystal phase at a temperature of 23° C.

Next, a polymeric film containing triacetylcellulose as the main component with a thickness of 80 μm (trade name of ‘ZRF80S’, manufactured by Fuji Photo Film Co., Ltd) was immersed in an aqueous solution in which sodium hydroxide was dissolved, so that alkali treatment (also referred to as saponification treatment) was performed on the film surface. The contact angle of water on this polymeric film at a temperature of 23° C. was 64.6° before the alkali treatment and 26.5° after the treatment. Next, the prepared aqueous solution was coated (wet thickness: 2.5 μm) on the alkali-treated surface of the polymeric film by using a bar coater (trade name of ‘mayer rot HS1.5’, manufactured by BUSCHMAN CORPORATION). After coating, the coating film surface was dried in a thermostatic chamber at a temperature of 23° C. while blowing a wind thereon. In this manner, a birefringent film A was produced on the surface of the polymeric film (base material). This birefringent film A satisfied a relationship of nx>nz>ny.

The properties of the birefringent film A according to Example 1 are shown in Table 1.

TABLE 1

| | | | | | Reference | Reference |
|---|---|---|---|---|---|---|
| | Example 1 | Example 2 | Example 3 | Example 4 | Example 1 | Example 2 |
| first derivative:second | 80:20 | 65:35 | 50:50 | 20:80 | 100:0 | 0:100 |
| derivative | | | | | | |
| Nz coefficient | 0.15 | 0.25 | 0.31 | 0.43 | 0.07 | — |
| Thickness (μm) | 0.6 | 0.7 | 0.6 | 0.4 | 0.7 | — |
| Δn_{xy}[590] | 0.30 | 0.30 | 0.25 | 0.16 | 0.30 | — |
| Δn_{xz}[590] | 0.05 | 0.07 | 0.08 | 0.07 | 0.02 | — |
| T[590] (%) | 90 | 90 | 90 | 90 | 90 | — |
| Re[590] (nm) | 195 | 210 | 141 | 63 | 221 | — |
| Rth[590] (nm) | 32 | 48 | 45 | 26 | 14 | — |

### Example 2

The aqueous solutions obtained in the above synthesis example 2 and synthesis example 3 were mixed so that the mixing ratio of the solid components of the acenaphtho[1,2-b]quinoxaline-2,5-disulfonic acid obtained in the above synthesis example 2 and the acenaphtho[1,2-b]quinoxaline-2-sulfonic acid obtained in the above synthesis example 3 would be 65:35. Next, this mixed aqueous solution was prepared by using a rotary evaporator so that the concentration of the aforesaid quinoxaline derivatives in the aqueous solution would be 25% by mass. When the prepared solution was observed with a polarization microscope, this solution exhibited a nematic liquid crystal phase at a temperature of 23° C.

The prepared aqueous solution was coated and dried on the polymeric film in the same manner as Example 1, so that a birefringent film B was produced on the surface of the polymeric film (base material). This birefringent film B satisfied a relationship of nx>nz>ny.

The properties of the birefringent film B according to Example 2 are shown in Table 1.

### Example 3

The aqueous solutions obtained in the above synthesis example 2 and synthesis example 3 were mixed so that the mixing ratio of the solid components of the acenaphtho[1,2-b]quinoxaline-2,5-disulfonic acid obtained in the above synthesis example 2 and the acenaphtho[1,2-b]quinoxaline-2-sulfonic acid obtained in the above synthesis example 3 would be 50:50. Next, this mixed aqueous solution was prepared by using a rotary evaporator so that the concentration of the aforesaid quinoxaline derivatives in the aqueous solution would be 22% by mass. When the prepared solution was observed with a polarization microscope, this solution exhibited a nematic liquid crystal phase at a temperature of 23° C.

The prepared aqueous solution was coated and dried on the polymeric film in the same manner as Example 1, so that a birefringent film C was produced on the surface of the polymeric film (base material). This birefringent film C satisfied a relationship of nx>nz>ny.

The properties of the birefringent film C according to Example 3 are shown in Table 1.

### Example 4

The aqueous solutions obtained in the above synthesis example 2 and synthesis example 3 were mixed so that the mixing ratio of the solid components of the acenaphtho[1,2-b]quinoxaline-2,5-disulfonic acid obtained in the above synthesis example 2 and the acenaphtho[1,2-b]quinoxaline-2-sulfonic acid obtained in the above synthesis example 3 would be 20:80. Next, this aqueous solution was prepared by using a rotary evaporator so that the concentration of the aforesaid quinoxaline derivatives in the aqueous solution would be 13% by mass. When the prepared solution was observed with a polarization microscope, this solution exhibited a nematic liquid crystal phase at a temperature of 23° C.

The prepared aqueous solution was coated and dried on the polymeric film in the same manner as Example 1, so that a birefringent film D was produced on the surface of the polymeric film (base material). This birefringent film D satisfied a relationship of nx>nz>ny.

The properties of the birefringent film D according to Example 4 are shown in Table 1.

### Reference Example 1

The aqueous solution containing the acenaphtho[1,2-b]quinoxaline-2,5-disulfonic acid obtained in the above synthesis example 2 was used. This aqueous solution was prepared by using a rotary evaporator so that the concentration of the acenaphtho[1,2-b]quinoxaline-2,5-disulfonic acid in the aqueous solution would be 25% by mass. When the prepared solution was observed with a polarization microscope, this solution exhibited a nematic liquid crystal phase at a temperature of 23° C.

The prepared aqueous solution was coated and dried on the polymeric film in the same manner as Example 1, so that a birefringent film F was produced on the surface of the polymeric film (base material). This birefringent film F satisfied a relationship of nx>nz>ny.

The properties of the birefringent film F according to Reference Example 1 are shown in Table 1.

### Reference Example 2

The aqueous solution containing the acenaphtho[1,2-b]quinoxaline-2-sulfonic acid obtained by the above synthesis example 3 was used. This aqueous solution was prepared by using a rotary evaporator so that the concentration of the acenaphtho[1,2-b]quinoxaline-2-sulfonic acid in the aqueous solution would be 12% by mass. When the prepared solution was observed with a polarization microscope, this solution exhibited a nematic liquid crystal phase at a temperature of 23° C.

The prepared aqueous solution was coated and dried on the polymeric film in the same manner as Example 1. However, the quinoxaline derivative was crystallized during drying and a film that can be used as a birefringent film was not obtained.

### [Evaluations]

From the results of Examples 1 to 4, a higher compounding ratio of the first derivative (acenaphtho[1,2-b]quinoxaline-2,5-disulfonic acid) allows a birefringent film having a comparatively lower Nz coefficient to be obtained. On the other hand, a higher compounding ratio of the second derivative (acenaphtho[1,2-b]quinoxaline-2-sulfonic acid) allows a birefringent film having a comparatively higher Nz coefficient to be obtained. In this manner, it can be seen that the Nz coefficient of a birefringent film is relatively changed in accordance with the compounding ratio of the first and second derivatives. Accordingly, by properly setting the compounding ratio of the first and second derivatives, a birefringent film having a desired Nz coefficient can be obtained. From the result of Reference Example 2, a birefringent film was not obtained by using only the second derivative (acenaphtho[1,2-b]quinoxaline-2-sulfonic acid).

1. A birefringent film comprising:
a first acenaphtho[1,2-b]quinoxaline derivative exhibiting lyotropic liquid crystallinity, represented by the following general formula (X1); and
a second acenaphtho[1,2-b]quinoxaline derivative exhibiting lyotropic liquid crystallinity, represented by the following general formula (Y1);
wherein an index ellipsoid satisfies a relationship of nx≧nz>ny: 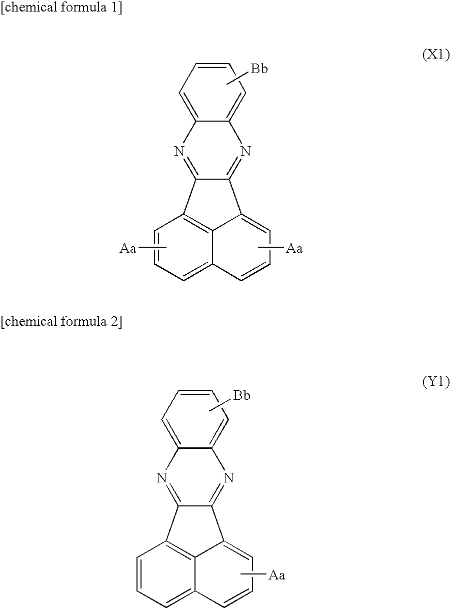
wherein in the formula (X1) and the formula (Y1), A each independently represents a substituent selected from —COOM, —SO₃M, —PO₃M, —OM, —NH₂, and —CONH₂ (M is a counterion); a represents a substitution number thereof (an integer of 1 to 3); B each independently represents a substituent selected from a halogen atom, —COOM, —SO₃M, —PO₃M, —OM, —NH₂, —NO₂, —CF₃, —CN, —OCN, —SCN, —CONH₂, —OCOCH₃, —NHCOCH₃, an alkyl group with a carbon number of 1 to 4, and an alkoxy group with a carbon number of 1 to 4 (M is a counterion); and b represents a substitution number thereof (an integer of 0 to 4).

2. The birefringent film according to claim 1, wherein the first acenaphtho[1,2-b]quinoxaline derivative is represented by the following general formula (X2): 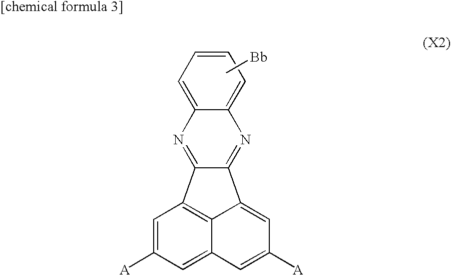
wherein in the formula (X2), A, B, and b are the same as the formula (X1).

3. The birefringent film according to claim 1, wherein the first acenaphtho[1,2-b]quinoxaline derivative is represented by the following general formula (X3): 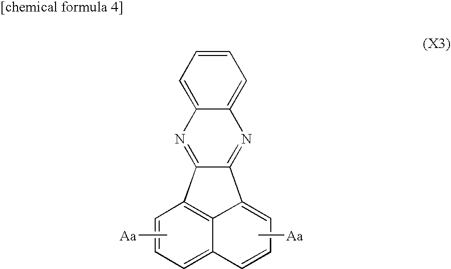
wherein in the formula (X3), A and a are the same as the formula (X1).

4. The birefringent film according to claim 3, wherein A of the general formula (X3) is —COOM or —SO₃M.

5. The birefringent film according to claim 1, wherein the second acenaphtho[1,2-b]quinoxaline derivative is represented by the following general formula (Y2): 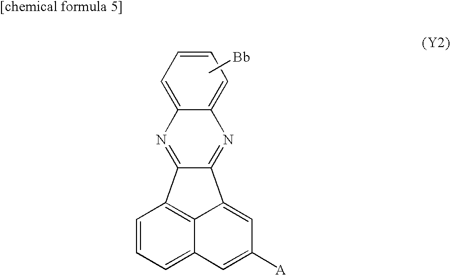
wherein in the formula (Y2), A, B, and b are the same as the formula (Y1).

6. The birefringent film according to claim 1, wherein the second acenaphtho[1,2-b]quinoxaline derivative is represented by the following general formula (Y3): 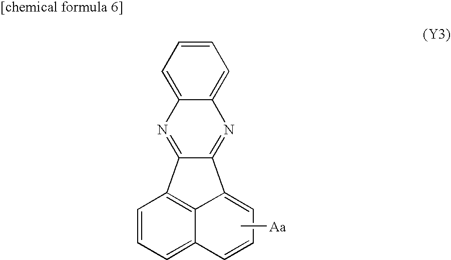
wherein in the formula (Y3), A and a are the same as the formula (Y1).

7. The birefringent film according to claim 6, wherein A of the general formula (Y3) is —COOM or —SO₃M.

8. The birefringent film according to claim 1, wherein with respect to 100 parts by mass of the total solid content, the first acenaphtho[1,2-b]quinoxaline derivative is contained by 1 part by mass to 99 parts by mass and the second acenaphtho[1,2-b]quinoxaline derivative is contained by 1 part by mass to 99 parts by mass.

9. The birefringent film according to claim 1, being obtained by coating and drying a solution containing the first acenaphtho[1,2-b]quinoxaline derivative and the second acenaphtho[1,2-b]quinoxaline derivative on a base material.

10. The birefringent film according to claim 1, wherein an Nz coefficient is 0 to 0.5.

11. The birefringent film according to claim 1, wherein an in-plane retardation value (Re[590]) at a wavelength of 590 nm is 20 nm to 1000 nm.

12. The birefringent film according to claim 1, wherein a retardation value (Rth[590]) in the thickness direction at a wavelength of 590 nm is 0 nm to 1000 nm.

13. A laminated film comprising:
the birefringent film according to claim 1; and another film.

14. The laminated film according to claim 13, wherein the another film comprises a polarizer.

15. An image display device comprising the birefringent film according to claim 1.
